(19) United States
(12) Patent Application Publication
(10) Pub. No.: US 2009/0028534 A1
(43) Pub. Date: Jan. 29, 2009

(54) Device for Heating an Air Stream in a Motor Vehicle

(75) Inventors: Dietmar Hartmann, Jettingen (DE); Peter Maly, Stuttgart (DE); Karl Pfahler, Stuttgart (DE); Lothar Renner, Nufringen (DE); Ina Von Szczepanski, Stuttgart (DE)

Correspondence Address: CROWELL & MORING LLP;INTELLECTUAL PROPERTY GROUP, P.O. BOX 14300, WASHINGTON, DC, 20044-4300, US

(73) Assignee: DaimlerChrysler AG, Stuttgart (DE)

(21) Appl. No.: 11/884,888

(22) PCT Filed: Feb. 16, 2006
(86) PCT No.: PCT/EP2006/001388

§ 371 Date: Apr. 2, 2008

(30) Foreign Application Priority Data
Feb. 23, 2005 (DE) 10 2005 008 596.2
Feb. 23, 2005 (DE) 20 2005 008 318.6

(51) Int. Cl. H05B 3/78

(52) U.S. Cl. 392/485

(57) ABSTRACT

A heating device for heating an air stream in a motor vehicle has at least one heating layer, preferably consisting of electrically heatable material, and at least one air-throughflow layer through which the air stream can pass. The air-throughflow layer has a structure by which the air stream can be converted into a turbulent or diffuse flow. For this purpose, the structure of the air-throughflow layer preferably has a multiplicity of spacer threads, webs and wires, or the like.

This application is a national stage of PCT International Application No. PCT/EP2006/001388, filed Feb. 16, 2006, which claims priority under 35 U.S.C. § 119 to German Patent Application No. 10 2005 008 596.2, filed Feb. 23, 2005, and German Patent Application No. 20 2005 008 318.6, filed Feb. 23, 2005, the disclosures of which are expressly incorporated by reference herein.

### BACKGROUND AND SUMMARY OF THE INVENTION

The invention relates to a heating device for heating an air stream, particularly for a motor vehicle.

In a heating device of the generic type, known, for example, in European patent document EP 1 182 908 B1, a plurality of PTC heating elements operable by electrical current are arranged within a position frame and form a heating layer, for heating a multiplicity of corrugated ribs of an air-throughflow layer. The corrugated ribs in this case form individual ducts, which heat the air stream generated by a blower, as it flows through them.

One disadvantage of this known heating device is that the air stream generated by the blower flows essentially in laminar form through the individual partial ducts formed by the corrugated ribs. As a result, each of the partial air streams flowing through the individual ducts absorbs heat from the corresponding corrugated rib essentially only in the boundary layer region with the respective wall surface of said corrugated rib. This leads to an extremely unfavorable temperature distribution, as seen in cross section, within each of the partial air streams. Furthermore, the air stream or the partial air streams flow relatively quickly through the individual ducts running in the flow direction, so that only a little heat can be transferred from the corrugated ribs to the air stream or the partial air streams. It is clear that the efficiency of the present heating device can be improved markedly.

Since the known heating device allows an air throughflow only according to the orientation of the individual air ducts, the installation possibilities are also correspondingly limited. Moreover, the known heating device is produced from metal and has a correspondingly rigid design, so that it is extremely difficult to adapt to available construction spaces.

One object of the present invention therefore is, to provide a heating device of the type initially mentioned, with improved efficiency, and with better possibilities for use.

This and other objects and advantages are achieved by the heating device according to the invention, in which the air-throughflow layer is provided with a structure that can convert the entering air stream into a turbulent or diffuse flow. Such a turbulent or diffuse flow has the advantage that, with a correspondingly comparable blower power, it can absorb far more heat than the largely laminar flow provided in the prior art. In contrast to the laminar flow described in the prior art, in the present case, not only are the boundary layers coming directly into contact with a corrugated rib heated, but also a much larger air fraction. Furthermore, the generated turbulent or diffuse flow generated causes the air stream to dwell for longer in the air-throughflow layer, so that more heat can be absorbed.

The turbulent or diffuse flow of the air stream is achieved by structuring the air-throughflow layer to include a multiplicity of spacer threads, webs, wires or the like. One possible configuration of this air-throughflow layer may be gathered as known, for example, from German patent document DE 198 05 178 C2 which relates to a knitted spacer structure in a ventilated vehicle seat (and to the contents of which reference is hereby made expressly). The knitted spacer structure described there comprises a multiplicity of spacer webs or threads which run transversely with respect to the outer wide sides of the knitted spacer structure and around which a turbulent or diffuse air flow can flow.

The spacer webs or threads in this case are arranged with respect to one another in specific patterns by which the flow direction and flow velocity can be influenced. In this respect it may be noted that the spacer webs or spacer threads may have the most diverse possible cross-sectional shapes, such as, for example, circular, oval, rectangular, square or the like. The spacer webs or threads in this case may be oriented or unoriented with respect to one another, and may consist of the most diverse possible materials. It has proved to be particularly advantageous to design the spacer webs or threads as a knitted structure, woven structure or braided structure. It is nevertheless conceivable to arrange the spacer threads or spacer webs, unoriented, in the manner of a wool. It is clear that such a knitted structure, woven structure or braided structure also has, as compared with the prior art, a far larger flow-around surface for the discharge of heat to the air flowing through.

Moreover, it has been shown to be particularly advantageous to produce the structure of the air-throughflow layer from a highly conductive metal such as, for example, an aluminum or copper alloy. Metal threads of this type are particularly suitable for discharging heat to the air flowing around. Thus, due to the large flow-around surface of the multiplicity of spacer threads, wires or webs, a highly effective heating device can be provided.

Moreover, an above-described structure consisting of spacer webs, wires or threads has the advantage that it can be designed so as to be elastically resilient. It is thereby possible to adapt the air-throughflow layer or the overall sandwich consisting of the heating layer and of the air-throughflow layer in a correspondingly simple way to the construction space within which the heating device is to be arranged. In this respect, it has been shown to be particularly advantageous to design the heating layer as resistance heating in the form of a thin-layered deformable and preferably elastic ply.

A particularly high heating power of the heating layer can be achieved if the latter is assigned a highly heat-conductive covering layer by which the heat generated by the resistance heating is distributed uniformly within the heating layer. It is possible for the highly heat-conductive covering layer to be, in particular, a metal foil or a metal sheet consisting, for example, of an aluminum or copper alloy.

A particularly effective sandwich of the heating device is afforded in that at least three air-throughflow layers are provided, a heating layer being arranged in each case between the middle and the outer air-throughflow layers. The central middle air-throughflow layer is thus supplied with heat from the two heating layers flanking it, so that the air stream flowing through the middle layer can be heated particularly quickly. The two outer air-throughflow layers are therefore supplied with heat only by the adjacent heating layer, so that a lower heating of the air stream flowing through them occurs in this region. This ensures, inter alia, that there is no overheating of the components surrounding this sandwich, such as, for example, a housing or further parts adjacent thereto.

Moreover, in the case of a plurality of layers combined into a sandwich, their flow resistance may be configured differently. For example, the distance between and orientation of the individual spacer webs, wires or threads of each layer may be different. Thus, for example, what can be achieved by a correspondingly finer-mesh knitted structure or woven structure or the like of the middle of the three air-throughflow layers is that the air stream flowing through them dwells there longer than in the two outer layers. As a result, this gives rise to a correspondingly better heat penetration of the air stream flowing through.

In the simplest embodiment, the sandwich consisting of the heating layer and the air-throughflow layer has a planar configuration. In this case, the number of air-throughflow layers and of the heating layers arranged between them can be selected or extended, as desired. The external dimensions of the sandwich can also be configured, as desired. Furthermore, the sandwich consisting of the air-throughflow layer and of the heating layer may also be of essentially worm-shaped design and be designed to be extendable, in cross section, to any desired diameter.

In a further preferred embodiment, a centrally arranged air-throughflow layer is surrounded circumferentially by a heating layer, which achieves particularly rapid and homogeneous heating of the air stream flowing through. A further air-throughflow layer may be provided on the circumference of the heating layer, in which case, in a preferred embodiment, the air stream flowing through the central layer is heated to a greater extent than the air stream flowing through the layer arranged circumferentially. This set-up makes it possible to have an air stream which can be heated very quickly and sharply in the central air-throughflow layer, whereas the air stream passing through the outer air-throughflow layer arranged circumferentially has a lower temperature, and therefore adjacent components, such as, for example, a housing wall, cannot be overheated. It is apparent that such a centrically constructed arrangement of air-throughflow layers, if appropriate with heating layers arranged between them, can be extended as desired. Furthermore, both circular and oval arrangements of the heating layers may be envisaged, and others of a similar nature as well.

Other objects, advantages and novel features of the present invention will become apparent from the following detailed description of the invention when considered in conjunction with the accompanying drawings.

### BRIEF DESCRIPTION OF THE DRAWINGS

FIG. 1 is a diagrammatic sectional view of a first embodiment of the heating device according to the invention, in which two heating layers are arranged between three air-throughflow layers;

FIG. 2 is a diagrammatic sectional view of a further embodiment of the heating device according to the invention, in which a plurality, (extendable as desired) of air-throughflow layers are separated from one another heating layers,

FIG. 3 is a diagrammatic perspective view of the heating device according to a third embodiment, in which the sandwich consisting of the air-throughflow layer and the heating layer is wound essentially in the form of a worm and arranged within an air duct;

FIG. 4 is a diagrammatic cross section through the heating device according to a fourth embodiment in which a central air-throughflow layer is surrounded circumferentially by a heating layer and by a further air-throughflow layer;

FIG. 5 is a diagrammatic cross section through the heating device according to a fifth embodiment which differs from the set-up of the heating device according to FIG. 4 in an essentially oval cross section;

FIGS. 6a, 6b are respectively a top view, and a sectional view along the line VIb-VIb in FIG. 6a, through the structure of the air-throughflow layer according to a first embodiment;

FIGS. 7a, 7b are respectively a top view, and a sectional view along the line VIIb-VIIb in FIG. 7a, through the structure of the air-throughflow layer according to a second embodiment;

FIGS. 8a, 8b are respectively a diagrammatic top view, and a diagrammatic sectional view along the line VIIIb-VIIIb in FIG. 8a, through the structure of the air-throughflow layer according to a third embodiment;

FIG. 9 is a diagrammatic top view of the structure of the air-throughflow layer according to a fourth embodiment; and

FIGS. 10a, 10b are respectively a diagrammatic top view and a sectional view along the line Xb-Xb in FIG. 10a, through the structure of the air-throughflow layer according to a fifth embodiment.

### DETAILED DESCRIPTION OF THE DRAWINGS

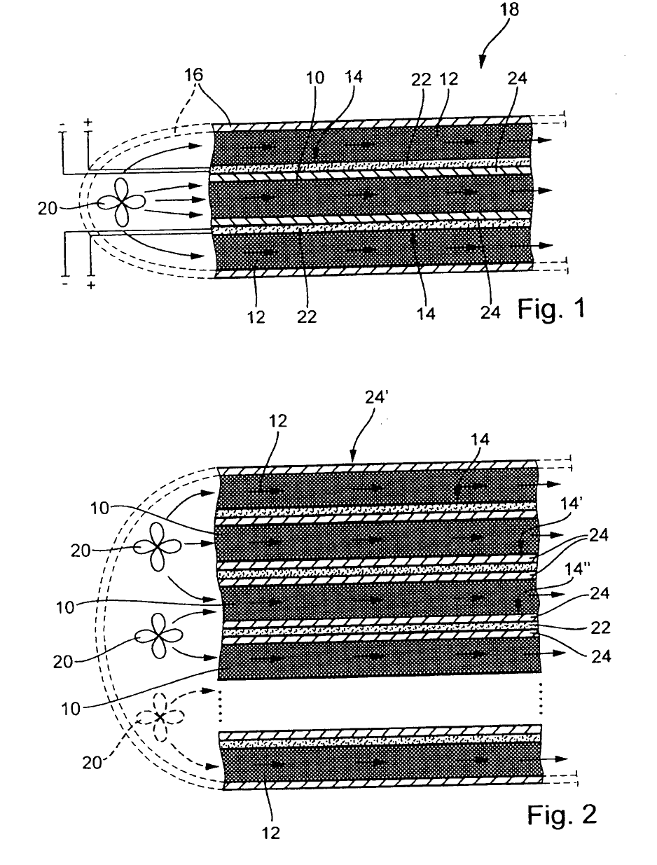

FIG. 1 is a diagrammatic sectional illustration of a heating device for heating an air stream, particularly within a motor vehicle, in which a middle air-throughflow layer 10 and two outer air-throughflow layers 12 and also two heating layers 14, described in more detail later, are combined into a sandwich 18. In the illustrated embodiment, this sandwich 18 is arranged within a housing 16 or an air duct which is produced, for example, from a conventional plastic. Within the housing 16, the sandwich 18 is preceded by a blower 20, of which only a fan wheel, indicated diagrammatically, can be seen in FIG. 1. The blower 20 can generate an air stream which, in the present exemplary embodiment, can flow through the three air-throughflow layers 10, 12.

The heating layer 14 arranged between the middle air-throughflow layer 10 and the respectively assigned outer air-throughflow layer 12 comprises in each case resistance heating capable of being supplied with electrical current, and in the present case is designed as a thin-layered deformable and elastic ply 22. Each of the two heating layers 14 is assigned a highly heat-conductive covering layer 24 which adjoins the wide side of the middle air-throughflow layer 10. In the exemplary embodiment shown, the covering layer 24 is produced from a highly heat-conductive metal foil or a metal sheet consisting, in particular, of an aluminum or copper alloy. In the present exemplary embodiment, all the layers 10, 12, 14, 22 and 24 are designed in planar form so as to bear closely one against the other.

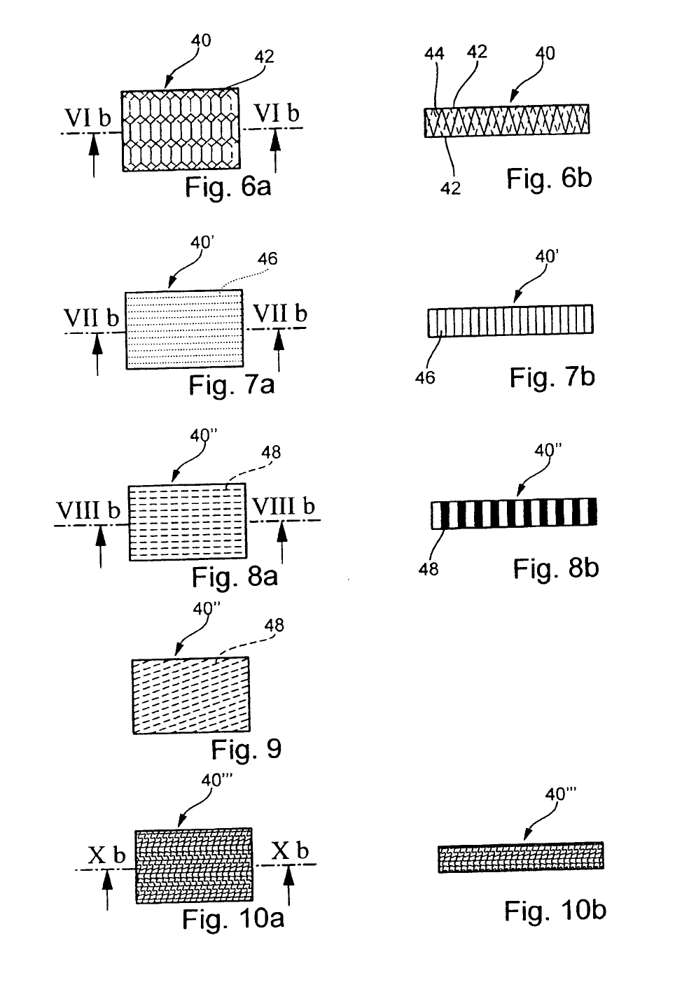

When an air stream is generated by the blower 20 upstream of the sandwich 18, it passes via the respective narrow side into the middle air-throughflow layer 10 and into the two outer air-throughflow layers 12. In the present exemplary embodiment, the three air-throughflow layers 10, 12 are produced from a knitted spacer structure, described in more detail below with reference to FIGS. 6a and 6b, which consists of a multiplicity of spacer threads or spacer webs. The spacer threads or spacer webs in this case run essentially transversely to the flow direction of the air stream or transversely to the wide sides of the air-throughflow layers 10, 12.

Instead of a knitted spacer structure of this type, of course, a woven structure, braided structure or wool-like structure produced from a multiplicity of spacer threads or the like may also be used. In other words, the spacer webs or threads may either be oriented with respect to one another (as already described, for example, in the German patent document DE 198 05 178 C2), or else, as is customary with wool, be unordered with respect to one another. Thus, an air stream generated by the blower 20, when it flows through the respective air-throughflow layer 10, 12, is deflected correspondingly frequently at the spacer threads or spacer webs.

Even after a short travel, a turbulent diffuse flow is established within the respective air-throughflow layer 10, 12. As compared with a laminar flow, this diffuse flow generated by means of the spacer threads or webs dwells longer within the associated air-throughflow layer 10, 12 and can absorb correspondingly more heat via the heating element 14 consisting of the resistance heating ply 22 and of the covering layer 24. Moreover, the diffuse distribution of the air stream within the respective air-throughflow layer 10, 12 has the effect that not only do individual boundary layers come into contact with the respective heating layer 14, but also a good and homogeneous intermixing of the air flow is achieved.

Since the middle air-throughflow layer 10 is delimited on its two wide sides in each case by a heating layer 14 or a covering layer 24, the air stream passing through the middle air-throughflow layer 10 is heated to a particularly great extent. Since the two outer air-throughflow layers 12 come into contact only on their wide side facing the middle layer 10 with the heating layer 14 or its resistance heating ply 22, the two air streams passing through the outer air-throughflow layer 12 are each heated to a lesser extent than the air stream passing through the middle air-throughflow layer 10. This ensures, inter alia, that the wall of the housing 16 cannot be overheated due to high temperatures of the air streams passing through the outer air-throughflow layers 12. In other words, the two part air streams flowing through the outer air-throughflow layers 12 act as a kind of heat insulator for the central hotter part air stream.

Moreover, in the present embodiment, the middle air-throughflow layer 10 has a higher flow resistance than the two outer air-throughflow layers 12 flanking it, because that the spacer threads or webs of the middle air-throughflow layer 10 are arranged more closely to one another so that the knitted structure or woven structure, overall, has a closer-mesh or denser configuration than the structure of the two outer air-throughflow layers 12. As a result, with the entry velocity of all the air streams on the entry side of the air-throughflow layers 10, 12 being the same, the partial air stream through the middle layer 10 flows through more slowly than the two partial air streams which pass through the two outer layers 12. By virtue of different velocities, therefore, more or less heat can be absorbed by the individual air streams.

Moreover, on the exit side, a layering (desirable if appropriate) of the overall air stream can be achieved, specifically with a middle hotter air stream from the middle layer 10 and with two outer, somewhat less hot air streams from the outer layers 12. The hot air stream generated by the heating device may be employed for the most diverse possible applications, particularly within the passenger compartment of a motor vehicle. Thus, for example, applications in the region of the vehicle windshield for supplying heating nozzles or defroster nozzles with hot air may be envisaged; and also the supply of other specific spaces, the foot space or the like within the motor vehicle is conceivable. Furthermore, the heating device also may be used in connection with the heating, ventilation and air-conditioning of a motor vehicle seat. Furthermore, the heating device may be appropriately employed within the motor vehicle seat for supplying the seat occupant's head region, shoulder region and neck region.

FIG. 2 shows a diagrammatic sectional view of the heating device according to a second embodiment, in which a sandwich 18′ comprises a plurality of air-throughflow layers 10, 12 and heating layers 14. As indicated by dashes, the sandwich 24′ may in this case be supplemented by one or more middle air-throughflow layers 10 and thus have a variable thickness. In the embodiment shown here, three middle air-routing layers 10 and, on the outside, in each case an outer air-throughflow layer 12 are arranged. In each case, at least one heating layer 14 is provided between the individual air-throughflow layers 10, 12. The sandwich 24′ in this case is once again arranged within a housing 16 and, in the present embodiment, follows a plurality of blowers 20. The number of fans 20 in this case may be varied depending on the thickness of the sandwich 24. Thus, it is conceivable that each fan 20 is provided for specific air-throughflow layers 10, 12, or else that all the fans 20 generate an overall air stream which can then be introduced into the air-throughflow layers 10, 12.

While, in FIG. 2, the uppermost heating layer 14 is identical to the uppermost heating layers 14 according to FIG. 1, the heating layers 14′, 14″ second from the top and third from the top, as seen from above, each have a different set-up. Where the heating layer 14′ second from the top is concerned, a covering layer 24 is provided in each case directly adjacent to the middle air-throughflow layer 10 lying above it and below it and once again is produced from a highly heat-conductive metal sheet or a metal foil. Each of the two covering layers 24 is in each case assigned a resistance heating ply 22 as already described with reference to FIG. 1.

The set-up of the heating layer 14″ third from the top differs from this set-up of the heating layer 14′ second from the top in that, instead of two resistance heating plies 22, only one is arranged between the two covering layers 24 and therefore these two covering layers 24 are heated. As regards the functioning of the heating device according to FIG. 2, reference is made to the functioning of the heating device according to FIG. 1 which is different with the exception of the different number of the air-throughflow layers 10 used or the heating layers 14 assigned in this case.

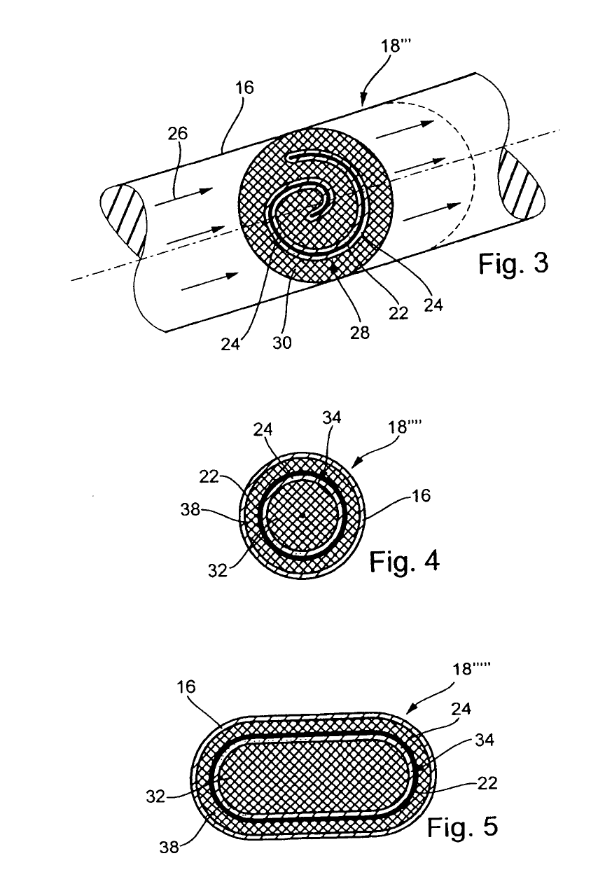

FIG. 3 shows a diagrammatic perspective illustration of the heating device according to a third embodiment, which is arranged within a housing 16 designed as a tubular air duct. Within this housing 16 is provided, upstream of the sandwich 18′″, explained in more detail later, a blower (not shown) which generates an air stream illustrated by arrows 26. The sandwich 18′″ consists essentially of a heating layer 28 and of an air-throughflow layer 30 and is wound up into a worm or coil of approximately circular cross section. The air-throughflow layer 30 in this case is formed in such a way that it completely surrounds the heating layer 28 circumferentially, and the heating layer 28 consists, in turn, of a resistance heating ply 22 which is covered on each of its two wide sides by a covering layer 24, preferably consisting of a metal foil or of a metal sheet.

It is apparent that central portions of the air-throughflow layer 30 are flanked on their two wide sides by the heating layer 28. In these regions, therefore, a high heating of the air stream is possible. By contrast, the portions of the air-throughflow layer 30 which lie on the outside circumferentially or are adjacent to the wall of the housing 16 are flanked on only one wide side (to be precise the inner side) of the heating layer 28. Consequently, that part of the air stream which flows through the outer regions of the air-throughflow layer 30, adjacent to the wall of the housing 16, is heated to a lesser extent than the above-described inner parts of the overall air stream. As a result, this also gives rise, as seen in cross section, to a layering of the overall air stream, a central part air stream being heated to a greater extent than an outer part of the air stream. It is clear that the air-throughflow layer 30 may also comprise a plurality of portions which have a different flow resistance.

FIG. 4 is a diagrammatic cross-sectional view of the heating device according to a fourth embodiment, in which the sandwich 18″″ is arranged within a housing designed as a tubular air duct 16. The sandwich 18″″ in this case comprises a central air-throughflow layer 32 of approximately circular overall cross section, surrounded circumferentially by a heating layer 34. The heating layer 34 comprises a covering layer 24 consisting of metal sheet or metal foil, which is adjacent to the outer surface area of the air-throughflow layer 32 and which is again surrounded on the outside by a resistance heating ply 22. On the outer circumference of the heating layer 34, an outer air-throughflow layer 38 is provided which runs between the heating layer 34 and the wall of the housing 16. Here, too, it is evident that the centrally arranged air-throughflow layer 32 can be heated to a greater extent than the outer air-throughflow layer 38. Here, too, the central air-throughflow layer 32 and the outer air-throughflow layer 38 may offer a different flow resistance to the air stream flowing through.

FIG. 5 illustrates the heating device according to a fifth embodiment, which differs essentially from the embodiment according to FIG. 4 only in that, in the present case, an oval cross section of the sandwich 18′″″ has been selected. Accordingly, in FIG. 5, components are designated by the same reference symbols as in FIG. 4.

The sandwiches 18′″, 18″″, 18′″″ according to FIGS. 3 to 5 can be extended radially, as desired, depending on the diameter of the housing 16. The sandwiches 18′″, 18^{IV}, 18^{V} can also be configured, as desired, in their length, depending on what heating of the air stream is to be achieved.

FIGS. 6a and 6b illustrate, respectively, a diagrammatic top view and a diagrammatic sectional view along the line VIb-VIb in FIG. 6a, of one possible structure 40 of the air-throughflow layers 10, 12, 30, 32, 38. The structure 40 here consists of what is known as a knitted spacer structure which comprises in each case on its upper and lower wide side a covering layer in the form of a honeycomb structure 42. Between the upper and lower covering layer 42 extend a multiplicity of spacer threads or spacer webs 44 which essentially extend transversely with respect to the two covering layers 42. By virtue of the orientation of and distance between the spacer threads or spacer webs 42, the flow resistance of the structure 40 in this case can be varied, and therefore the flow velocity of the air stream passing through the structure 40 can be set. In the present exemplary embodiment, the spacer threads or spacer webs 44 may be produced, in particular, from a plastic. In a special embodiment, instead of the spacer threads or spacer webs 44, spacer wires or the like are also used which are preferably produced from a highly heat-conductive metal, such as from an aluminum alloy or a copper alloy. Metal wires of this type have the advantage, as compared with plastic threads, that they can additionally discharge the heat, generated by means of the heating layer, particularly effectively to the turbulent or diffuse flow of the air stream passing through the air-throughflow layer.

FIGS. 7a and 7b are, respectively, a diagrammatic top view and a diagrammatic sectional view along the line VIIb-VIIb in FIG. 7a of the structure 40′ of the air-throughflow layers 10, 12, 30, 32, 38, according to a further embodiment. In this case, spacer webs or spacer wires 46 run perpendicularly with respect to the two wide sides of the structure 40′. As can be seen from FIG. 7a, the spacer webs or spacer wires 46 are arranged in series with one another.

FIGS. 8a and 8b are, respectively, a diagrammatic top view and a diagrammatic sectional view along the line VIIIb-VIIIb in FIG. 8a, of a further structure 40″ in which spacer webs 48 of essentially rectangular cross section extend between the two wide sides of the structure 40″. As shown by comparison with FIG. 9 (which shows a top view of the arrangement of the spacer webs 48 in an alternative configuration), it becomes clear that the webs may be oriented longitudinally, transversely or obliquely with respect to the flow direction of the air stream flowing through the air-throughflow layer.

Finally, FIGS. 10a and 10b are, respectively, a diagrammatic top view and a sectional view along the line Xb-Xb in FIG. 10a of a structure 40′″, in which the spacer threads, spacer webs or spacer wires are arranged so as to be unoriented with respect to one another in the manner of a wool. The spacer threads, spacer webs or spacer wires in this case may be produced, in particular, from a plastic or from metal.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1.-25. (canceled)

26. A device for heating an air stream in a motor vehicle, said device comprising:
at least one heating layer made of electrically heatable material; and
at least one air-throughflow layer through which the air stream can pass; wherein
the air-throughflow layer has a structure, which converts the air stream into a turbulent or diffuse flow.

27. The device as claimed in claim 26, wherein the structure of the air-throughflow layer comprises a multiplicity of spacer threads, webs, or wires.

28. The device as claimed in claim 26, wherein the air-throughflow layer comprises one of a knitted structure, a woven structure, and a braided structure.

29. The device as claimed in claim 26, wherein the air-throughflow layer is configured in an unordered structure, in the manner of one of a wool and a metal wool.

30. The device as claimed in claim 26, wherein the air-throughflow layer is delimited on each of its two wide sides by a covering layer.

31. The device as claimed in claim 30, wherein the covering layers have a substantially honeycomb structure.

32. The device as claimed in claim 26, wherein the structure of the air-throughflow layer is produced from one of a plastic and a heat conductive metal.

33. The device as claimed in claim 26, wherein the structure of the air-throughflow layer is slightly deformable.

34. The device as claimed in claim 26, wherein the structure of the air-throughflow layer is elastically resilient.

35. The device as claimed in claim 26, wherein the heating layer comprises a resistance heating and is designed as a thin-layered deformable ply.

36. The device as claimed in claim 26, wherein the heating layer has a highly heat-conductive covering layer which is arranged between the heating layer and the air-throughflow layer.

37. The device as claimed in claim 26, wherein the covering layer comprises one of a metal foil and a metal sheet.

38. The device as claimed in claim 26, wherein:
at least three air-throughflow layers are provided; and
a heating layer is arranged between a middle layer and each of the outer air-throughflow layers.

39. The device as claimed in claim 38, wherein the two heating layers have a heat-conductive covering layer on their inside in each case facing the middle air-throughflow layer.

40. The device as claimed in claim 38, wherein a structure of an inner air-throughflow layer has a higher flow resistance than a structure of outer air-throughflow layers.

41. The device as claimed in claim 38, wherein two outer air-throughflow layers are covered on the outside by a housing wall layer.

42. The device as claimed in claim 26, wherein each air-throughflow layer is assigned a blower which blows air in on a narrow side of the layer.

43. The device as claimed in claim 26, wherein a sandwich consisting of the air-throughflow layer and of the heating layer is wound up essentially in the form of a worm.

44. The device as claimed in claim 43, wherein the air-throughflow layer is surrounded circumferentially by the heating layer.

45. The device as claimed in claim 44, wherein the heating layer is surrounded circumferentially by a further air throughflow layer.

46. The device as claimed in claim 26, wherein the structure of the inner air-throughflow layer has a higher flow resistance than the structure of the circumferentially outer air-throughflow layer.

47. The device as claimed in claim 26, wherein the heating device has an essentially circular or oval cross section.
